(19) United States
(12) Patent Application Publication
(10) Pub. No.: US 2007/0072581 A1
(43) Pub. Date: Mar. 29, 2007

(54) Method and apparatus for marking of emergency image data

(76) Inventor: Naveen Aerrabotu, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 11/238,286

(22) Filed: Sep. 29, 2005

(51) Int. Cl. H04M 11/04

(52) U.S. Cl. 455/404.1

(57) ABSTRACT

A method and apparatus is provided for recording and preserving information in an emergency situation. A portable communication device (120) automatically activates (310) its recording device (228) thereof, which includes a still or video camera (232), to record emergency data in response to detecting an emergency input (302) and provides the emergency data to public safety personnel (316). The emergency data is marked (312) so that it may be preserved by controlling inadvertent or intentional deletion thereof (326, 520) and by identifying the emergency data when displayed (324, 510).

### FIELD OF THE INVENTION

The present invention generally relates to communication systems, and more particularly relates to a method and apparatus for emergency recording and preserving of visual image data by a portable communication device in such communication systems.

### BACKGROUND OF THE INVENTION

Today's portable communication devices have a multitude of functions in addition to the traditional point-to-point audio communications. Modern portable communication devices can record multimedia signals, such as photos or videos, with or without accompanying audio and, in addition, can transmit and receive such multimedia signals. In addition, today's modern portable communication devices can determine their location utilizing Global Positioning Satellites (GPS) or the longitude and latitude of base stations communicating therewith, and, in emergencies, transmit that location to a service provider so that emergency services can be dispatched to the location. In this manner, when a person is the victim of a crime, they can activate the emergency feature on their phone and have police and/or rescue services dispatched. While the portable communication devices can contact emergency services, many such devices also have the ability to record visual information relating to the emergency situation. If the user is disabled, however, the record features on the portable communication device cannot be activated. In addition, if the visual information is recorded and stored in the device, it may be valuable for legal or investigative purposes. Yet, the information could be intentionally or unintentionally deleted by the user or anyone else who has access to the portable communication device.

Thus, what is needed is a method and apparatus for automatically enabling the recording capabilities of a portable communication device during an emergency situation to record visual information. In addition, what is needed is a method and apparatus for automatically protecting that visual information from intentional or inadvertent deletion. Furthermore, other desirable features and characteristics of the present invention will become apparent from the subsequent detailed description and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a block diagram of a communication system in accordance with an embodiment;

FIG. 2 is a block diagram of a portable communication device of the communication system of FIG. 1 in accordance with an embodiment;

FIG. 3 is a flowchart of the operation of the portable communication device of FIG. 2 in accordance with an embodiment;

FIG. 4 is a block diagram of a public safety access device of the communication system of FIG. 1 in accordance with an embodiment; and

FIG. 5 is a flowchart of the operation of the public safety access device of FIG. 4 in accordance with an embodiment.

### DETAILED DESCRIPTION

A method and apparatus is provided for recording and identifying emergency image data. A portable communication device having a recording device with a camera detects an emergency user input and activates the recording device in response to such detection. Activating the recording device includes configuring the camera to record images using emergency settings and configuring the recording device to mark recorded data as emergency data. The camera could be a digital still camera and the recording device could add information to an EXIF file of the JPEG emergency data, or the camera could be a movie camera and the recording device could add information to the MPEG emergency data.

The following detailed description is merely exemplary in nature and is not intended to limit the invention or the application and uses of the invention. Furthermore, there is no intention to be bound by any theory presented in the preceding background of the invention or the following detailed description.

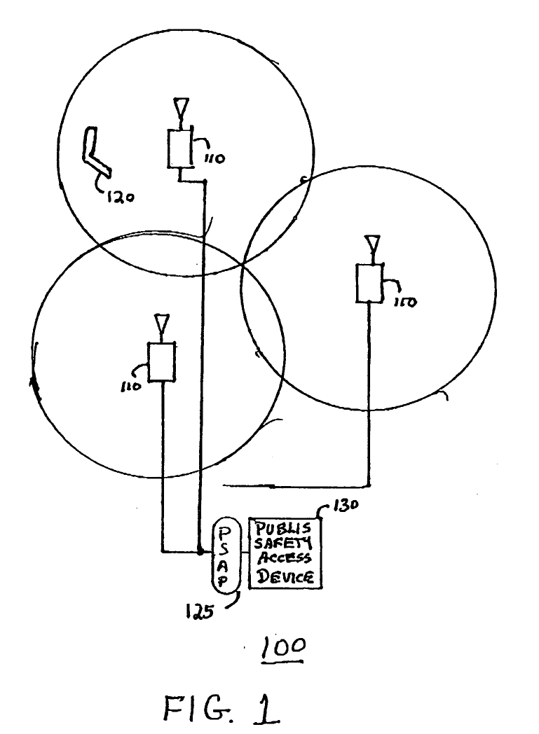

Referring to FIG. 1, a communication system 100 in accordance with an embodiment includes a plurality of base stations 110 and a portable communication device 120. The plurality of base stations 110 communicate with the portable communication device 120 in any of a number of conventional protocols (e.g., CDMA) on assigned channels.

Many such communication systems 100 enable the portable communication device 120 to quickly contact fire, police or other emergency services by providing a Public Safety Answering Point (PSAP) 125 through which the portable communication device 120 can contact a public safety answering device 130 in an emergency.

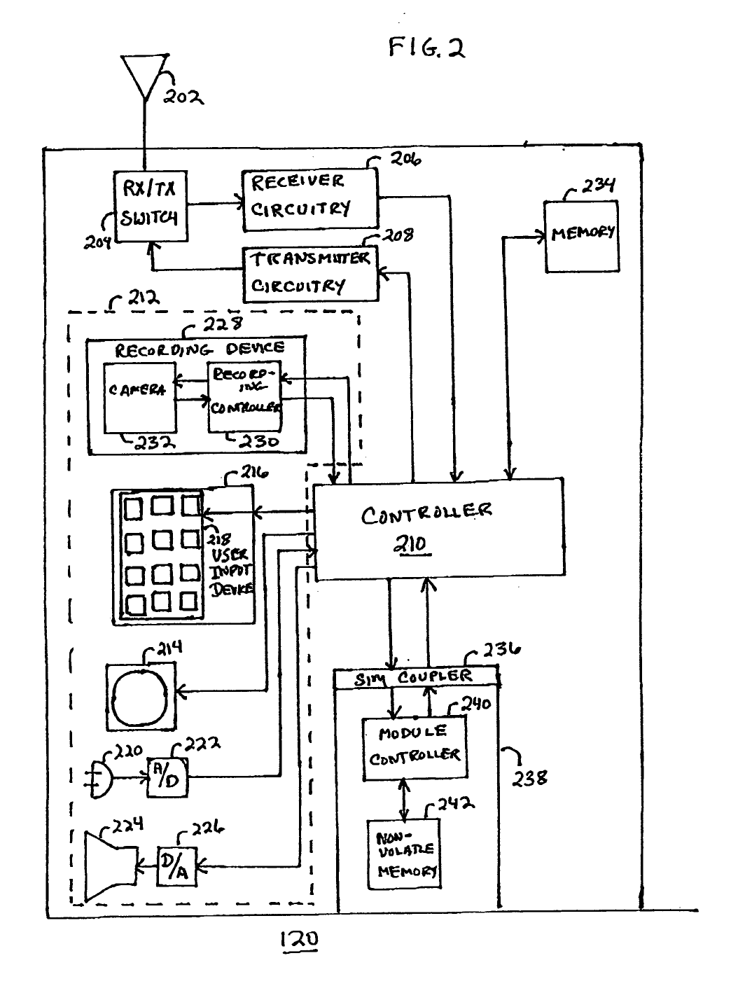

FIG. 2 shows a portable communication device 120 in accordance with the embodiment. The portable communication device 120 includes an antenna 202 for receiving and transmitting radio frequency (RF) signals. A receive/transmit switch 204 selectively couples the antenna 202 to receiver circuitry 206 and transmitter circuitry 208 in a manner familiar to those skilled in the art. The receiver circuitry 206 demodulates and decodes the RF signals to derive information and is coupled to a controller 210 for providing the decoded information to the controller 210 for operation in accordance with the function(s) of the portable communication device 120. The controller 210 also provides information to the transmitter circuitry 208 for encoding and modulating information into RF signals for transmission from the antenna 202.

The controller 210 is coupled to user interface circuitry 212 including, for example, a display 214 for presenting video output to a user, a user input device 216, including a keypad 218, for receiving user input thereon, a microphone 220 for receiving voice input which is converted to digital signals by an analog-to-digital (A/D) converter 222, and a speaker 224 for providing audio output to the user after passing signals through a digital-to-analog (D/A) converter 226. In this embodiment, the user interface circuitry 212 also includes a recording device 228 including a recording controller 230 coupled to a camera 232, such as a digital still camera for taking pictures or a video camera for recording movies. The recording controller 230 is coupled to the controller 210.

The controller 210 is also coupled to a nonvolatile memory device 234 for storing information and for retrieving and utilizing information. Additionally, the controller 210 is coupled to coupler 236 for physically and electrically coupling a Subscriber Identity Module (SIM) 238 to the portable communication device 120. The SIM includes a module controller 240 coupled to a non-volatile memory 242 for storing information and retrieving information, and further coupled to the coupler 236.

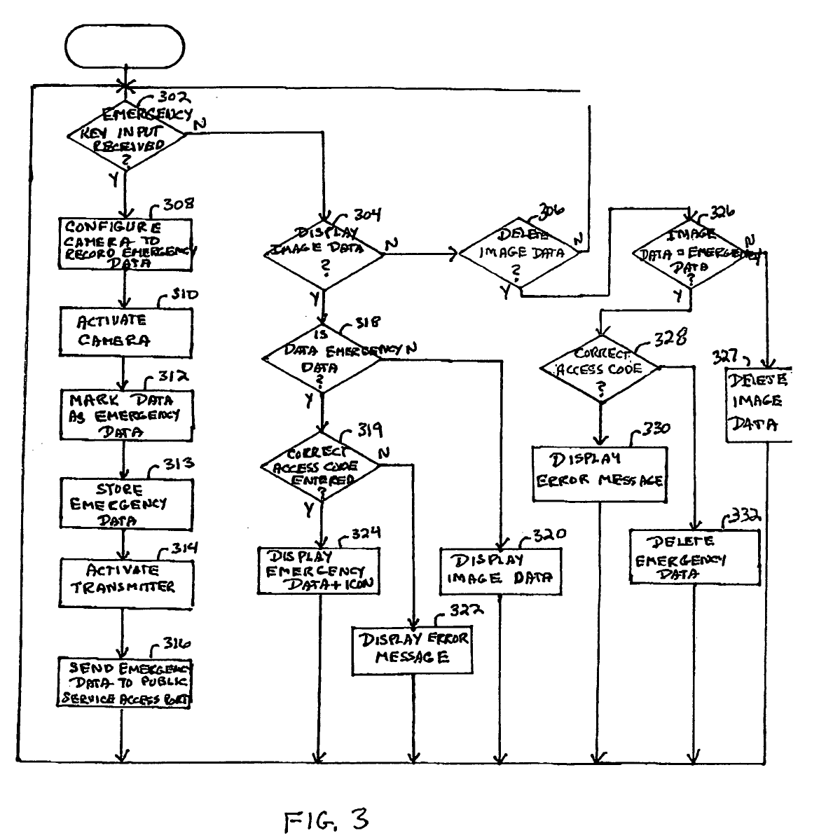

Referring to FIG. 3, a flowchart of the operation of the controller 210 in accordance with an embodiment initially examines signals from the user input device 216 to determine whether an emergency input has been detected 302, a predetermined user input indicative of presenting recorded data on the display 214 has been detected 304, or a predetermined user input indicative of deleting recorded data has been detected 306.

If the controller 210 detects 302 an emergency signal generated by the user input device 216 in response to a predetermined input from, for example, activation of one or more user activatable keys of the keypad 218 or after an emergency call connection has been established with the PSAP 125, the controller 210 then generates an emergency record signal and provides it to the recording controller 230 to launch and configure the camera 232 to pre-defined emergency settings by configuring 308 various camera parameters such as resolution, brightness and other attributes. The recording controller 230 then activates the camera 232 to record multimedia data 310 representing visual information seen by the camera 232 and, in the case of a video camera, audio information picked up by the microphone 220 or another microphone associated with the video camera. For example, a still camera 232 could take digital pictures or a video camera 232 could record audio and visual information as a movie. Alternatively, if the phone is equipped with multiple cameras 232, then the recording controller 230 would, in response to the emergency record signal, configure 308 the cameras 232 to record in accordance with emergency settings, such as an external camera taking pictures or recording in accordance with the emergency settings, then auto-rotating at a pre-defined speed while the other camera records or takes pictures 310. The cameras could also be configured 308 to take multiple pictures at a pre-determined frequency. Even with a still camera 232, if the portable communication device 120 has the capability of recording audio information, the recording controller 230 could be configured to activate the microphone 220 to begin recording audio information when the camera 232 is activated to record visual information 310.

The recording controller 230 then marks 312 the recorded data as emergency data. The recorded data is digital information which includes both image information and header information, and the recording controller 230 marks 312 the data recorded by the recording device as emergency data by adding predetermined data to the header information of the recorded data. For example, since the recording device 228 is typically a digital camera module in the portable communication device 120, conventional digital camera specifications (such as JPEG) or digital video and audio specifications (such as MPEG) are used for the data recorded by the recording device 228.

Specifications for JPEG and MPEG are not really based on a use case of a camera module housed in a portable communication device 120, such as a cell phone. With regards to JPEG data, the identity aspects developed or inserted into the specifications are based on digital cameras and, when developed, did not account for cell phones with imagers. JPEG is the most widely used digital imaging format that is commonly used to store pictures from a camera. Besides information about the pixels of the image, most cameras store additional header information such as the date and time the image was taken, the aperture and shutter speed, the ISO, and most other camera settings. This data, also known as “metadata”, is stored in a header, a common type of which is the EXIF (Exchangeable Image File) header. EXIF is a standard for storing information created by JEIDA (Japan Electronic Industry Development Association) to encourage interoperability between imaging devices and is a standard for storing interchange information in image files, especially those using JPEG compression. Most digital cameras now use the EXIF format. EXIF data is very useful because a user does not need to worry about remembering the settings used when taking the image. Later, the user can analyze on a computer which camera settings created the best results, so the user can learn from each experience.

Currently there is no method to mark multimedia content as content derived during an emergency call. In an embodiment, a new field added into the EXIF Header specifies that the image captured is during an emergency call, or, less preferably, could be marked in the comments fields of the specification if available. In addition to an emergency identifier in the field indicating that the data is emergency data, the information in this field also needs to identify the portable communication device 120 by storing the International Mobile Emergency Identity (IMEI), the Mobile Equipment Identifier (MEID), or the Electronic Serial Number (ESN) in the data field. In addition, for portable communication devices 120 with additional capabilities, the Mobile Identification Number (MIN), a ten digit number (represented by thirty-two bits) assigned to the portable communication device (or Mobile Station) 120, or the Mobile Directory Number (MDN), a dialable number assigned to the portable communication device 120, could be stored in the data field. In non-emergency situations the data field can be set to some default value.

In this manner, the recording controller 230 marks 312 the recorded data as emergency data. Similar additions can be made for MPEG to account for the emergency nature of any Imager Video Data taken by a recording device 228 that is a digital video camera module. Thus, the emergency data includes both image information and header information, wherein the header information is EXIF header information for a digital picture, MPEG header information for a digital movie, or similar header information, and the recording controller 230 is configured to mark 312 the recorded data as emergency data by adding predetermined data to a field of the EXIF header information or the MPEG header information or the like.

After recording the emergency data, the recording controller 230 provides the emergency data to the controller 210 which stores the emergency data in a non-volatile memory 313, such as the memory 234 or the non-volatile memory 242 of the SIM 238. The transmitter circuitry 208 is then activated 314 by the controller 210, and the controller 210 provides the emergency data as information to the transmitter 208 for encoding and modulating into signals for transmitting 316 from the portable communication device 120. A base station 110 of the communication system 100 receives the emergency data and, in accordance with conventional procedure, provides all information regarding the emergency call, including the emergency data, to the public safety answering device 130. Processing in the portable communication device 120 then returns to detect 302 if an input is received to make another emergency call, display 304 the emergency data, or delete 306 the emergency data.

If a predetermined user input has been received from the user input device 216 to present data on the display 214, such as the controller 210 detecting a recorded data display signal generated by the user input device 216 in response to detecting a predetermined user input indicative of presenting recorded data on the display 304, the controller 210 determines whether the data to be displayed is emergency data 318. If the data is not emergency data 318, it is displayed 320 and processing returns to await detection 302 of the next user input to receive emergency data, display 304 data, or delete 306 data.

In accordance with this embodiment, access to any emergency data is restricted. Accordingly, after determining that the data to be displayed is emergency data 318, the controller determines whether the user has access to view the emergency information 319 by, for example, requesting an additional predetermined security access code. The emergency data may be retrievable from the portable communication device 120 only through additional security procedures known to legal and emergency personnel or system personnel. If the user does not have access to view the emergency information 319, the controller 210 signals the display 214 to present an error message 322 (such as “INFORMATION INACCESSIBLE”) to the user. If the user has access to view the emergency information 319, an emergency data display signal is provided to the display such that the emergency imager data when displayed shows an icon indicating that it is multimedia data derived from an emergency call 324. In other words, the emergency data is presented on the display 214 together with the predetermined icon 324 in response to the emergency data display signal. The predetermined icon could be a graphic symbol, text, a “watermark”, or other graphic indicator presented on the display 214 during replay 324. After presentation of either the error message 322 or the emergency data with the predetermined icon 324, processing again returns to await detection 302 of the next user input to receive emergency data, display 304 data, or delete 306 data.

When the controller 210 receives a user delete signal from the user input device 216 generated in response to detecting a predetermined user input indicative of deleting 306 recorded data, the controller 210 determines whether the data to be deleted is emergency data 326. If the recorded data is not emergency data 326, it is deleted 327. If the recorded data is emergency data 326, it is not deleted unless additional security procedures are successfully passed. If a security code is entered, it is determined whether the security code is correct 328. If the security code is not correct 328 (or if the portable communication device does not permit deletion of emergency data by a general user), an error message 330 (such as “CANNOT DELETE DATA”) is presented to the user on the display 214. In accordance with this embodiment, the security code is not available to the user (i.e., it is neither provided to the user nor user downloadable). Instead, the security code is known only by the service provider and the manufacturer or other authorized personnel. If a correct 328 security code is received, the emergency data is deleted 332.

Thus, a mechanism is provided to protect the multimedia content automatically generated to be used for legal purposes by the controller 210 identifying emergency data as a system file or other data that cannot be deleted by the user through an input to the user input device 216 or deleted by a master clear command or a reset command. After either deletion of the data 328 or presentation of the error message 330, processing again returns to await detection 302 of the next user input to receive emergency data, display 304 data, or delete 306 data.

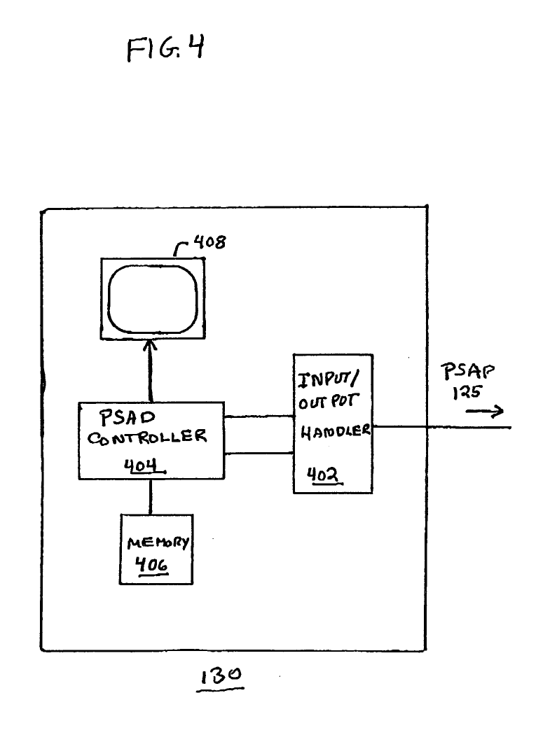

Referring to FIG. 4, a public safety answering device (PSAD) 130 coupled to the communication system 100 through a public safety answering point 125 (FIG. 1), includes, among other components, an input/output handler 402 for handling communications with the communication system 100, an emergency call information controller 404, a memory 406, a user input device 407 and a display 408. The input/output handler 402 is coupled to the controller 404 for providing data thereto (such as emergency data) received from the communication system 100. The controller 404 is coupled to the memory 406 for storing emergency data and other information therein, and is coupled to the display 408 for presenting information for emergency calls to public safety personnel. The user input device 407 is coupled to the controller 404 to provide user signals thereto for control of the operation of the PSAD 130.

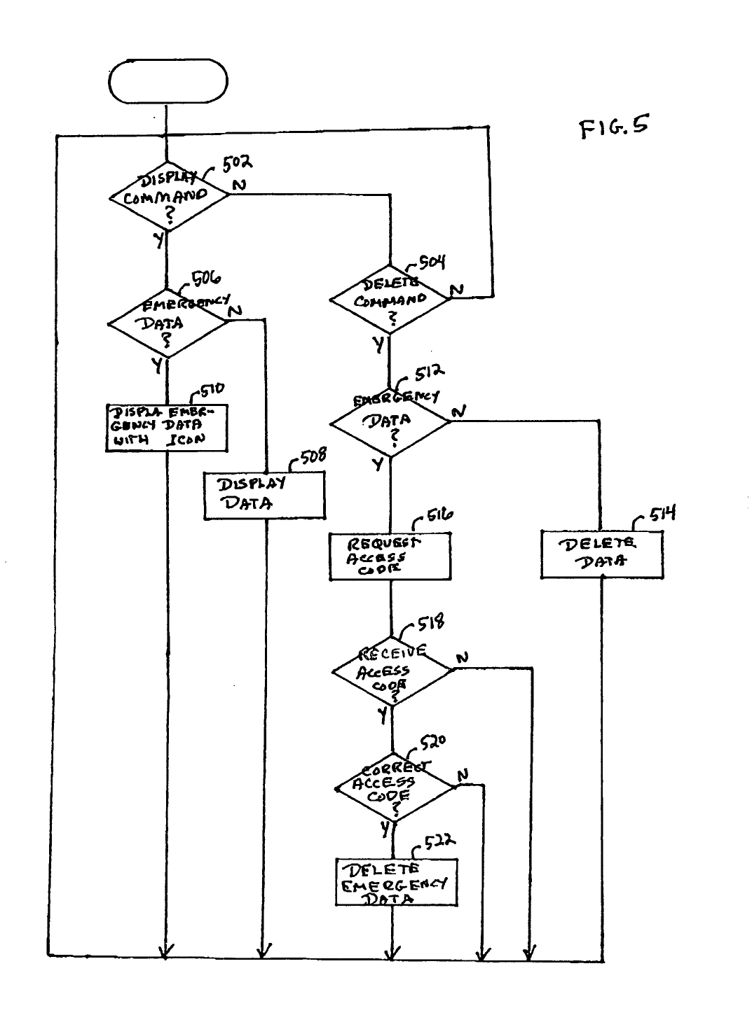

Referring to FIG. 5, operation of the PSAD controller 404 initially determines whether a command has been received from the user input device 407 of the PSAD 130 or in some other manner to either display information 502 on the PSAD display 408 or delete information 504 from the memory 406. For example, during a “911” emergency call from the portable communication device 120, there may be a flag set to provide an automatic command to display information on the PSAD display 408 in real time as it is received from the communication system 100 and, if receiving audio information from the portable communication device 120, presenting the audio information to emergency personnel in the public safety answering point 125. If a command has been received to display information 502, the PSAD controller 404 determines whether the information is emergency data 506 by examining the header information. If the information is not emergency data 506, the information is provided to the display 408 for display thereon 508. If the information is emergency data 506, a signal is provided to the display 408 to display the emergency data thereon together with a predetermined icon indicating to the public safety user that the information is emergency data 510. Processing in accordance with this embodiment then returns to await reception of another display command 502 or a delete command 504.

In response to a data delete command 504, the PSAD controller 404 examines the data to be deleted from the PSAD memory 406 to determine if it is emergency data 512. If the data is not emergency data 512, it is deleted 514 and processing returns to await a display command 502 or a delete command 504. If, on the other hand, the data to be deleted is emergency data 512, the PSAD controller 404 provides a query requesting a security code 516 that prevents unauthorized deletion of emergency data. If no security code is received 518 or if an input is received 518 but the input does not match a stored security code 520, processing returns to await a display or delete command 502, 504 without deleting the emergency data. When the security code is received 518 and it is determined that the inputted security code matches the stored security code 520, the emergency data is deleted 522 from the PSAD memory 406. Additionally, when emergency data is deleted 522 from the PSAD memory 406, the PSAD controller 404 can send a PSAD delete signal through the communication system 100 to the portable communication device 120. In response to receiving the PSAD delete signal, the controller 210 could either delete the emergency data stored in the memory 234 or the memory 242 or could “unmark” the emergency data so that it is no longer recognized as emergency data and can be allowed to be deleted during ordinary operation of the controller 210. Processing in accordance with this embodiment then returns to await the next display command 502 or delete command 504.

Thus, as wireless mobile manufacturers are making portable communication devices 120 with cameras 232, new opportunities to develop safety mechanisms for portable communication device 120 users can be provided. When a user makes an emergency call, the portable communication device 120 automatically enables the recording device 228 and a streaming video, streaming video and audio, picture or picture and audio content is delivered to a Public Safety Answering Point (PSAP) for viewing and recording and can only be retrieved and removed from the portable communication device 120 through additional security procedures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for emergency response in a portable communication device including a recording device, the method comprising the steps of:
detecting an emergency input from user interface circuitry of the portable communication device; and
activating the recording device in response to the emergency input.

2. The method of claim 1 wherein the step of activating the recording device comprises the steps of:
configuring the recording device in a predetermined manner; and
activating the recording device to record data in accordance with the predetermined manner.

3. The method of claim 2 wherein the step of configuring the recording device comprises the steps of:
configuring the recording device to mark recorded data as emergency data; and
configuring the recording device to record using emergency settings.

4. The method of claim 3 wherein the recording device comprises a camera and the recorded data comprises image information and header information and wherein the step of configuring the recording device to mark the recorded data comprises the step of configuring the camera to add predetermined data in the header information.

5. The method of claim 4 wherein the camera comprises a still camera, the image information comprises at least one picture, and the header information comprises EXIF header information, and wherein the step of configuring the camera to add predetermined data comprises the step of configuring the still camera to add predetermined data in the EXIF header information of each of the at least one picture.

6. The method of claim 4 wherein the camera comprises a video camera, the image information comprises at least one movie, and the header information comprises MPEG header information, and wherein the step of configuring the camera to add predetermined data comprises the step of configuring the video camera to add predetermined data in the MPEG header information of each of the at least one movie.

7. The method of claim 3 further comprising the steps of:
detecting a predetermined user input indicative of deleting recorded data;
determining whether the recorded data is emergency data;
deleting the recorded data if the recorded data is not emergency data; and
not deleting the recorded data if the recorded data is emergency data.

8. The method of claim 3 wherein the portable communication device comprises a display and wherein the method further comprises the steps of:
detecting a predetermined user input indicative of presenting recorded data on the display;
determining whether the recorded data is emergency data;
presenting the recorded data together with a predetermined icon if the recorded data is emergency data; and
presenting the recorded data without the predetermined icon if the recorded data is not emergency data.

9. The method of claim 1 wherein the portable communication device comprises a keypad comprising a plurality of user activatable keys and wherein the step of detecting an emergency input comprises the step of detecting activation of predetermined ones of the user activatable keys.

10. The method of claim 1 wherein the portable communication device comprises transmitter circuitry for transmitting signals from the portable communication device, and wherein the step of activating the recording device comprises the step of activating the recording device to record emergency data, the method further including the steps of:
activating the transmitter to encode and modulate information provided to the transmitter as signals for transmitting from the portable communication device; and
providing the emergency data recorded by the recording device to the transmitter as information for encoding and modulating into signals for transmitting from the portable communication device.

11. A portable communication device comprising:
a user input device for generating an emergency signal in response to a predetermined user input received by the user input device;
a recording device for recording data representing visual information seen from the portable communication device; and
a controller coupled to the user input device and the recording device for activating the recording device to record emergency data in response to detecting the emergency signal from the user input device.

12. The portable communication device of claim 11 wherein the recording device comprises a recording controller coupled to the controller, and wherein the controller generates an emergency record signal in response to detecting the emergency signal from the user input device, and wherein the recording controller generates emergency data in response to the emergency record signal by marking data recorded by the recording device as emergency data.

13. The portable communication device of claim 12 wherein the data recorded by the recording device comprises image information and header information and wherein the recording controller marks the data recorded by the recording device as emergency data by adding predetermined data to the header information to the recorded data.

14. The portable communication device of claim 13 wherein the header information is one of the group of EXIF header information and MPEG header information.

15. The portable communication device of claim 12 wherein the user input device generates a user delete signal in response to detecting a predetermined user input indicative of deleting recorded data and provides the user delete signal to the controller, and wherein the controller, in response to receiving the user delete signal, determines whether the recorded data is emergency data, deleting the recorded data if the recorded data is not emergency data and not deleting the recorded data if the recorded data is emergency data.

16. The portable communication device of claim 12 wherein the user input device generates a user delete signal in response to detecting a predetermined user input indicative of deleting recorded data and provides the user delete signal to the controller, and wherein the controller, in response to receiving the user delete signal, determines whether the recorded data is emergency data, deleting the recorded data if the recorded data is not emergency data and, if the recorded data is emergency data, requesting the user to enter a security access code, determining whether a received security access code is a valid security access code for deleting emergency data, deleting the emergency data if the received security access code is a valid security access code, and not deleting the emergency data if no security access code is entered or if the received security access code is not a valid security access code.

17. The portable communication device of claim 12 further comprising a display coupled to the controller for displaying information in response to data received from the controller, and wherein the user input device generates a recorded data display signal in response to detecting a predetermined user input indicative of presenting recorded data on the display and provides the recorded data display signal to the controller, and wherein the controller, in response to receiving the recorded data display signal, determines whether the recorded data to be displayed is emergency data and provides the recorded data and an emergency data display signal to the display if the recorded data is emergency data, and wherein the display presents the recorded data together with a predetermined icon in response to the emergency data display signal.

18. The portable communication device of claim 11 further comprising:
transmitter circuitry coupled to the controller for generating signals by encoding and modulating information received from the controller; and
an antenna coupled to the transmitter circuitry for transmitting the signals generated thereby, and wherein the controller provides the emergency data to the transmitter circuitry for generation of signals therefrom in response to the emergency input.

19. A communication system comprising:
a plurality of base stations;
a portable communication device for communicating with at least one of the plurality of base stations, the portable communication device comprising:
a user input device for generating an emergency signal in response to a predetermined user input received by the user input device;
a recording device for recording data representing visual information seen from the portable communication device;
transmitter circuitry for generating signals by encoding and modulating information received by the transmitter circuitry;
an antenna coupled to the transmitter circuitry for transmitting the signals generated by the transmitter circuitry; and
a controller coupled to the user input and the recording device for activating the recording device to record and mark emergency data in response to detecting the emergency signal from the user input device, the controller further coupled to the transmitter circuitry for providing the emergency data thereto for generation of emergency signals for transmitting from the antenna in response to the emergency input; and
a public safety answering device coupled to the at least one of the plurality of base stations for receiving the emergency signals.

20. The communication system of claim 19 wherein the portable communication device further comprises a memory coupled to the controller for storing data including the emergency data, and wherein the user input device of the portable communication device generates a user delete signal in response to detecting a predetermined user input indicative of deleting data from the memory and provides the user delete signal to the controller of the portable communication device, and wherein the controller, in response to receiving the user delete signal, determines whether the data stored in the memory is the emergency data, deleting the data if the data is not the emergency data and, if the data is the emergency data, requesting the user to enter a security access code, determining whether a security access code received from the user input device is a valid security access code for deleting emergency data, deleting the emergency data if the received security access code is a valid security access code, and not deleting the emergency data if no security access code is received from the user input device or if the received security access code is not a valid security access code.

21. The communication system of claim 19 wherein the public safety answering device (PSAD) comprises:
a PSAD memory device for storing the data including the emergency data; and
a PSAD controller coupled to the PSAD memory device for preventing deletion of data if the PSAD controller determines that the data is emergency data.

22. The communication system of claim 21 wherein the public safety answering device further comprises a PSAD display coupled to the PSAD controller for visually presenting information provided to the PSAD display by the PSAD controller, wherein the PSAD display visually presents information with a predetermined icon in response to the PSAD controller signaling the PSAD display that the information provided to the PSAD display is emergency information derived from emergency data.

23. The communication system of claim 21 wherein the public safety answering device further comprises a PSAD user input device, and wherein the PSAD controller permits deletion of emergency data stored in the PSAD memory device in response to receiving a predetermined user input from the PSAD user input device.

24. The communication system of claim 19 wherein the public safety answering device (PSAD) comprises a PSAD controller and a PSAD user input device coupled to the PSAD controller, and wherein the PSAD controller generates a PSAD delete signal in response to receiving a predetermined user input from the PSAD user input device, the PSAD controller providing the PSAD delete signal to the at least one of the plurality of base stations for transmission to the portable communication device.

25. The communication system of claim 24 wherein the portable communication device further comprises a memory coupled to the controller for storing data including the emergency data, and wherein the controller, in response to receiving the PSAD delete signal, determines whether the data stored in the memory is the emergency data and deletes the data if the data is the emergency data.

26. The communication system of claim 24 wherein the portable communication device further comprises a memory coupled to the controller for storing data including the emergency data, and wherein the controller, in response to receiving the PSAD delete signal, removes marking from the emergency data to allow deletion of the emergency data upon receipt of a user delete signal from the user input device.
